(19) United States
(12) Patent Application Publication
(10) Pub. No.: US 2006/0023402 A1
(43) Pub. Date: Feb. 2, 2006

(54) Mouse with a new storer for connecting line

(76) Inventor: Chang-Chung Chin, Hsin Tien City (TW)

Correspondence Address: LEONG C LEI, PMB # 1008, 1867 YGNACIO VALLEY ROAD, WALNUT CREEK, CA, 94598, US

(21) Appl. No.: 11/104,468

(22) Filed: Apr. 13, 2005

(30) Foreign Application Priority Data
Jul. 13, 2004 (TW) 093211024

(51) Int. Cl. G06F 13/38; H02B 1/00

(52) U.S. Cl. 361/600; 710/73

(57) ABSTRACT

The present invention offers a mouse with new storage for connecting line, of which a narrower buckle (compared to the front and rear ends) is placed at the center of the mouse body against the loosening of connecting line. As the mouse body is provided with a groove for embedding of the connector, the connecting line can thus be securely fastened. This portable device is optimally suited for storage and utilization along with its cost-saving feature.

### BACKGROUND OF THE INVENTION

(a) Technical Field of the Invention

The present invention relates generally to a wired mouse, and more particularly to an innovative mouse designed with a new storage for connecting line.

(b) Description of the Prior Art

In a fast-changing era, more and more portable computer products are made available in timely response to demanding requirements of people on user-friendly computers. While people can handle their own business via portable computer at any time or anywhere, particular attentions shall be paid to the user-friendliness of the computers' interface devices.

At present, most of the customers still use wired mouse in despite of existing development trend towards wireless mouse. So, different solutions are developed to address this issue for more convenience, such as the design of a coiler for retracting connecting line and the design of another storage space within the mouse body, etc. However, the common disadvantages between them lie in the increased cost of materials and some other shortcomings during utilization: the former design adds a coiler on the connecting line. But, when you move the mouse, the added weight will further lead to inconvenience and possible failure of slide bar. The latter one stores the connecting line within the mouse, and then pull back/out it via a spring winder, so the failure of operation will occur from time to time.

Therefore, the inventors herein shall give highest priority to these technical problems.

### SUMMARY OF THE INVENTION

The primary purpose of the present invention is to offer a mouse with new storage for connecting line, which can help recover or open the storage for the connecting line in a cost-effective way.

For this purpose, the technical package of the present invention consists of: a mouse with new storage for connecting line, which comprises a mouse body and a mouse connecting line with connector. A narrower buckle is placed at the center of the mouse body against the loosening of connecting line. And, the mouse body is provided with a groove for embedding of the connector.

The groove is achieved by slightly enlarging the shadow of one of six sides for the connector.

The groove is established at the bottom or lateral face of the mouse body. A shallow groove is also provided at the bottom of the mouse body for the embedding of connecting line, and extends towards the central section of the mouse body from the front end.

The shallow groove at the front end of mouse body is provided with a recess and the connecting line with an embedding block for inserting into the recess.

Based on the above-specified construction of the present invention, the body of the mouse is wrapped by the mouse connecting line, and the connector of connecting line is fixed into the groove for positioning of connecting line. Thus, it can resolve the unacceptable loosening of connecting line while promoting the portable convenience and ease-of-storage or utilization along with lower cost.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows the schematic drawing of mouse connecting line in a pull-down state.

FIG. 2 shows the schematic drawing of mouse connecting line wrapped into the buckle of the mouse body.

FIG. 3 shows the schematic drawing of mouse connecting line wrapped into the buckle of the mouse body and the connector embedded into the groove.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

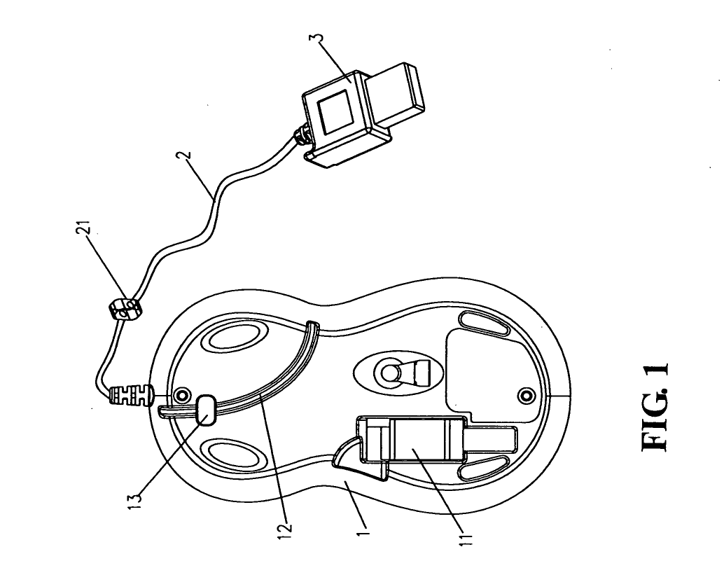

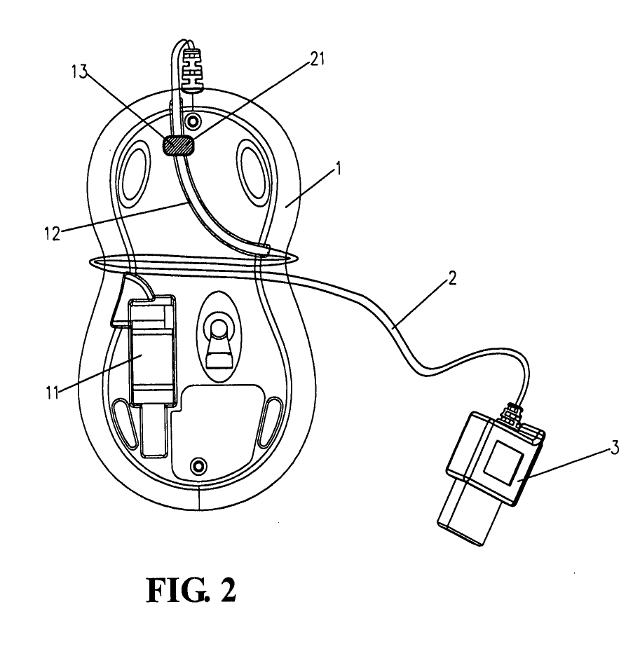

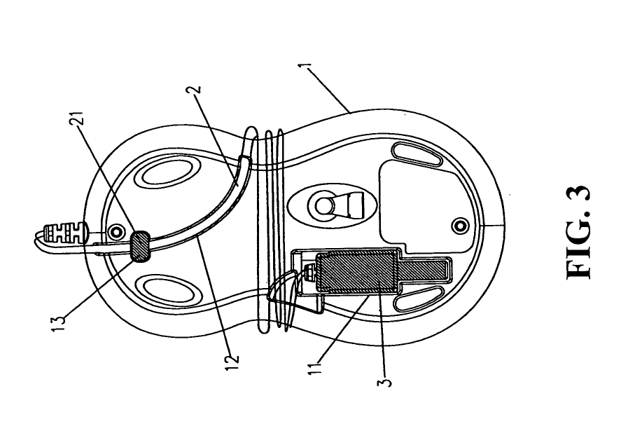

As shown in FIGS. 1-3, a mouse with new storage for connecting line embodied in the present invention comprises:
a mouse body 1 and a mouse connecting line 2 with a connector 3. A narrower buckle is placed at the center of the mouse body 1. And, the bottom of the mouse body 1 is provided with a groove for embedding of connector 3 and a shallow groove 11 for embedding of connecting line 2. The groove 111 is achieved by slightly enlarging the shadow of one of six sides of the connector 3, while shallow groove 12 extends towards the central section of the mouse body 1 from the front end. The shallow groove at the front end of mouse body is provided with a recess and the connecting line 2 with an embedding block 21 for inserting into the recess 13.

When storing the connecting line, the mouse will embed some sections of the lines into the shallow groove, and insert the embedding block into the recess for positioning of mouse connecting line. Meanwhile, the narrower buckle of the mouse body is wrapped by the mouse connecting line, and the connector is fixed into the groove. In this way, the anti-loosing mouse connecting line can be fastened to save the space.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. a mouse with new storage for connecting line comprises a mouse body and a mouse connecting line with a connector. The features include: a narrower buckle is placed at the center of the mouse body against the loosening of connecting line. And, the mouse body is provided with a groove for embedding of connector.

2. The mouse with a new storage for connecting line defined in claims 1, the groove is achieved by slightly enlarging the shadow of one of six sides of the connector.

3. The mouse with new storage for connecting line defined in claims 1 and 2, wherein said groove shall be provided at the bottom or lateral face of the mouse with new storage for connecting line.

4. The mouse with a new storage for connecting line defined in claims 1, a shallow groove is also provided at the bottom of the mouse body for embedding of connecting line, and extends towards the central section of the mouse body from the front end.

5. The mouse with a new storage for connecting line defined in claims 1, the shallow groove at the front end of mouse body is provided with a recess and the connecting line with an embedding block for inserting into the recess.
